(19) United States
(12) Patent Application Publication
(10) Pub. No.: US 2018/0038397 A1
(43) Pub. Date: Feb. 8, 2018

(54) Multi-Function Band and Method of Use

(71) Applicant: Noa Harrel, Santa Barbara, CA (US)

(72) Inventor: Noa Harrel, Santa Barbara, CA (US)

(21) Appl. No.: 15/724,595

(22) Filed: Oct. 4, 2017

Related U.S. Application Data
(63) Continuation-in-part of application No. 14/544,741, filed on Feb. 10, 2015, now abandoned.
(60) Provisional application No. 61/966,019, filed on Feb. 14, 2014.

(51) Int. Cl. F16B 2/08; A45D 8/34; A45D 8/36

(52) U.S. Cl. CPC F16B 2/08; Y10T 24/21; A45D 8/36; A45D 8/34

(57) ABSTRACT

A multi-function band and method therefore having a material formed into a body and an adjuster coupled with the body and accessible to the user wherein the user can use the bands as is for applications or withdraw a variable portion of the adjuster causing the material to be gathered into a formation for use in applications.

### CROSS-REFERENCE TO RELATED APPLICATIONS

This application is a continuation-in-part of U.S. patent application Ser. No. 14/544,741, entitled Multi Function Band, filed Feb. 10, 2015, which claimed the benefit and priority of U.S. Provisional Patent Application No. 61/966,019, filed Feb. 14, 2014, entitled “Multi Function Band.” U.S. App. Ser. No. 14/544,741 and U.S. Prov. Pat. App. Ser. No. 61/966,019 are incorporated by reference as if fully set forth herein.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND AN INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

The present invention relates to bands for use in variety of utilitarian and adornment applications or functions.

Bands have been used for many different applications, such as hair bands, protective bands, athletic bands, etc. However, these bands are limited to specific applications or functions.

Thus, there is a need in the art for a band which can be used for a wide variety of applications or functions with a simple operation by a user, which may be re-used repeatedly for any of these applications as the user desires, and which is economical to produce.

### SUMMARY OF THE INVENTION

A band operable by a user for use in a plurality of applications comprising: a material formed into the body of the band; an adjuster coupled with the body and accessible to the user; and wherein the user can use the band as is for applications or withdraw a variable portion of the adjuster causing the material to be gathered into a formation for use in applications.

The band as described above further comprising one or more adjuster openings in the body for access by the user to the adjuster.

The band as described above wherein the adjuster openings are holes in the material.

The band as described above wherein the reinforcement is an eyelet.

The band as described above wherein the adjuster openings are made by not joining together portions of the material when the body is formed.

The band as described above wherein the adjuster openings may be disposed in various locations for creating different appearances of the material when gathered by operation of the adjuster.

The band as described above further comprising an adjuster disposition means for loosely coupling the adjuster to the body.

The band as described above wherein the adjuster is comprised of a material with elastic-like qualities.

The band as described above further comprising an adjuster securing means for securing the adjuster in the variably withdrawn position selected by the user.

The band as described above wherein the material has absorbent qualities.

The band as described above wherein the material has decorative patterns thereon.

A band, operable by a user, for use in a plurality of applications comprising: a material formed into the body of the band, the body having a cavity there through one or more openings through the body to the cavity; an adjuster, disposed within the cavity and accessible to the user through the openings; wherein the user can use the band as is for applications or withdraw a variable portion of the adjuster from the body causing the material to be gathered into a formation for use in applications.

A method for forming a band from one or more pieces of material, such band operable by a user for use in a plurality of applications, comprising the steps of forming two or more layers of material; closing sides of open layers of the material opposite each other; creating a material opening by not closing a certain portion of one such opposite side; forming one or more adjuster openings; pulling each remaining open end of the material layers through the material opening; closing such pulled open material layers; pulling the closed material layers back through the material opening thereby hiding the closings of the material layers from view and forming a looped band having one or more cavities there through; and disposing an adjuster within the cavities such that the adjuster is accessible to the user through the one or more adjuster openings.

The method as described above further including the step of closing the material opening.

The method as described above wherein one or more portions of the material opening is not closed thereby forming the adjuster openings.

The method as described above wherein the material layers are created by folding a piece of material.

The method as described above wherein the step of forming one or more adjuster openings comprises leaving one or more openings in the closing of the pulled open material layers.

The method as described above wherein the step of forming one or more adjuster openings comprises forming a hole in a layer of the material for each adjuster opening.

The method as described above further comprising the step of reinforcing the adjuster openings.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1A is a functional diagram of the multi-function band depicting the band flipped to expose the interior ring of the multi-function band.

FIG. 1B is a functional diagram of the multi-function band depicting the external ring of the multi-function band.

FIG. 1C is a functional diagram of the multi-function band showing a close up of the adjustment mechanism on the interior ring of the multi-function band.

FIG. 2 is a perspective view of the multi-function band with the adjuster partially pulled.

FIG. 3 is a perspective view of the multi-function band with the adjuster fully pulled.

FIG. 4 is an environmental view of one embodiment of the multi-function band pulled and worn on a hat.

FIG. 5 is an environmental view of one embodiment of the multi-function band pulled and worn as a hair band.

FIG. 6 is an environmental view of one embodiment of the multi-function band pulled and worn as a hair band.

FIG. 7 is an environmental view of one embodiment of the multi-function band pulled and worn as a waist band.

FIG. 8 is an environmental view of one embodiment of the multi-function band pulled and worn as an ankle accessory.

FIG. 9 is an environmental view of one embodiment of the multi-function band pulled and worn as a wrist accessory.

FIG. 10 is an environmental view of one embodiment of the multi-function band pulled and used as a gift box accessory.

FIG. 11 is an environmental view of one embodiment of the multi-function band pulled and used as a handbag accessory.

FIG. 12 is an environmental view of one embodiment of the multi-function band not pulled and used as a hat accessory.

FIG. 13 is an environmental view of one embodiment of the multi-function band not pulled and used as a head band.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

While various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not limit the scope of the invention.

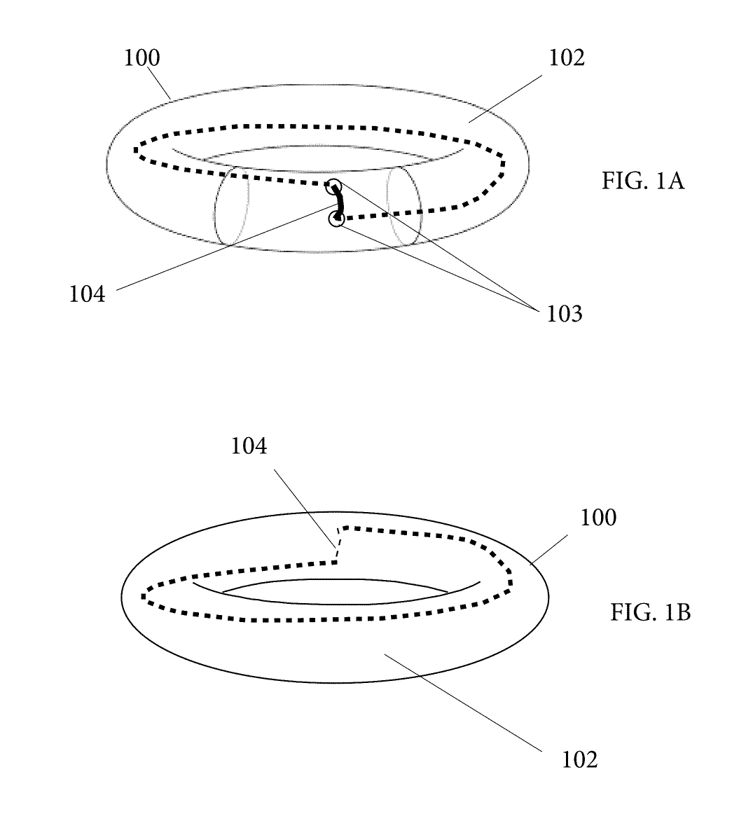

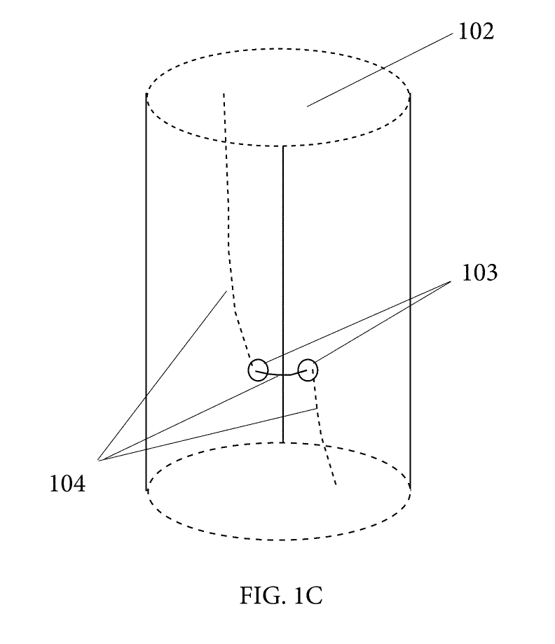

Referring now to FIG. 1A, a functional diagram of the multi-function band 100 is depicted showing the external side of the band 100. The band is comprised of a material or fabric which is formed into a circular band with a cavity 102. It will be understood that a wide variety of cloth materials or fabrics, such as cotton, lycra, nylon, polyester, or silk, may be used for the multi-function band 100 with qualities, including, but not limited to, absorbency, insulation, elasticity, durability, washable, etc., and any color or combinations of colors. Additionally, the material may have patterns or designs and may have images, patches, logos, lettering, and many other forms of decorations etc. therein and/or thereon. Still referring to FIG. 1A, in one embodiment, the multi-function band 100 is a donut shaped head band with an external and internal ring and at least two openings 103 positioned in line with one another, or in close proximity with one positioned above the other. The openings 103 provide an opening into the cavity 102 of the multi-function band 100, wherein the cavity 102 is exposed to the external environment. The multi-function band 100 features a cavity 102, wherein an adjuster 104 is disposed. The adjuster 104 may be an elastic string with stretchable characteristics. The adjuster 104 is a closed loop that inters through one opening 103, travels through the multi-function band 100 and exits out of the other opening 103, wherein the adjuster is tied-off, so that it is a closed loop. Referring to FIG. 1A the adjuster 104 is primarily disposed within the cavity 102, but there is a portion of the adjuster 104 that is exposed between the openings 103, wherein the user may grasp the exposed portion of the adjuster 104 and pull on the adjuster 104 to adjust the size of the circumference of the multi-function band. That is, the adjuster 104 is formed into a loop primarily disposed within the cavity 102 of the multi-function band 100 and accessible to a user through the adjuster openings 103. It will also be appreciated that the adjuster 104 may have other shapes such as, a single, linear piece of material. It will be further appreciated that the adjuster 104 may be coupled to the material of the multi-function band 100 in other ways, such as, coupling or attaching it along the internal side circumference of the multi-function band 100 and such ways of coupling may eliminate the need for the cavity 102 and/or the openings 103. Moreover, the disposition of the adjuster 104 may be varied such that the material of the multi-function band 100 is gathered in different ways (i.e, taught to resemble a headband (see FIG. 13) or “scrunched” (see FIG. 3)). FIG. 1B is a functional diagram of the multi-function band depicting the external ring of the multi-function band.

FIG. 1C is a functional diagram of the multi-function band 100 showing a close-up of the adjustment mechanism on the interior ring of the multi-function band, wherein an adjuster 104 is partially exposed between the two openings 103. In one embodiment, the openings 103 are formed by making holes in the material and are reinforced with eyelets or other suitable devices for protecting the material when the adjuster 104 is operated. It will be appreciated that the openings 103 may be reinforced with any suitable device such as, for example, eyelets, grommets or stitching or may not be reinforced at all. It will be further appreciated that the band 100 may have only one opening 103 or more than two openings 103 with which to operate the adjuster 104.

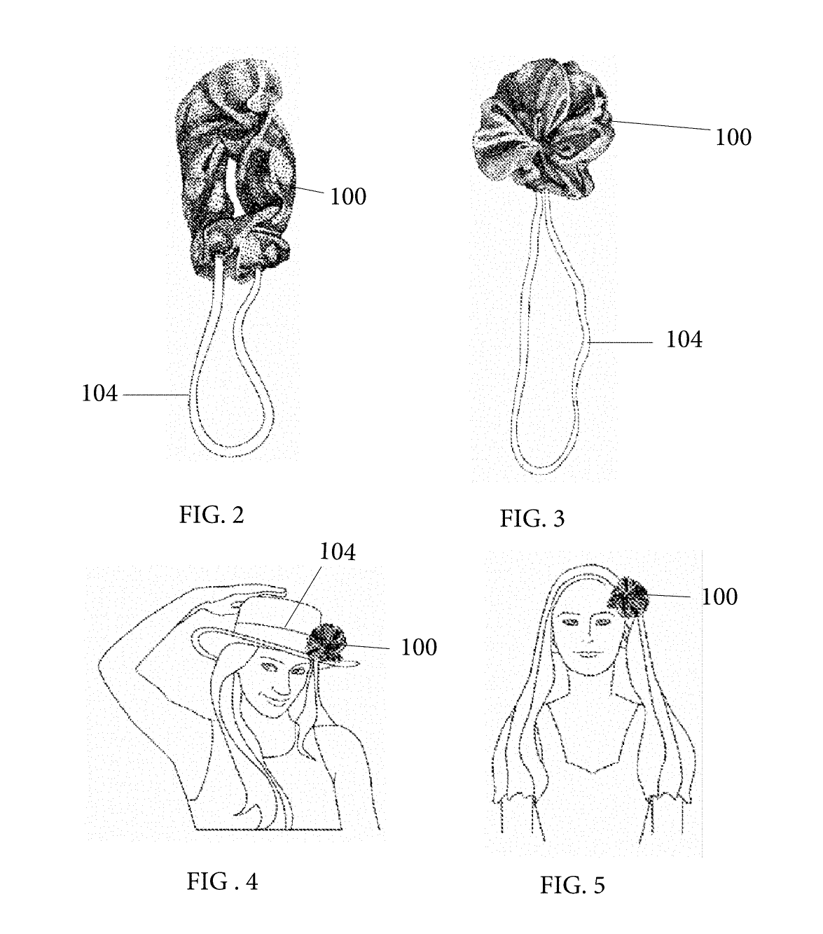

FIG. 2 is a perspective view of the multi-function band 100 with the adjuster 104 partially pulled. Referring to FIG. 2, the multi-function band 100 the adjuster 104 may be pulled to “scrunch” the multi-function band 100 to a smaller circumference. That is, as the adjuster 104 is partially withdrawn from the cavity 102, the material of the multi-function band is partially gathered.

FIG. 3 is a perspective view of the multi-function band 100 with the adjuster fully pulled. Referring to FIG. 3, the adjuster 104 may be fully pulled so that the multi-function band 100 is completely “scrunched,” wherein a substantial portion of the adjuster 104 is exposed and may be worn around a waist or appendage, or applied as an accessory to a hat, handbag, or other object. That is, as the user operates or pulls the adjuster 104, more of the adjuster 104 is withdrawn from the cavity 102 thereby gathering the material of the multi-function band.

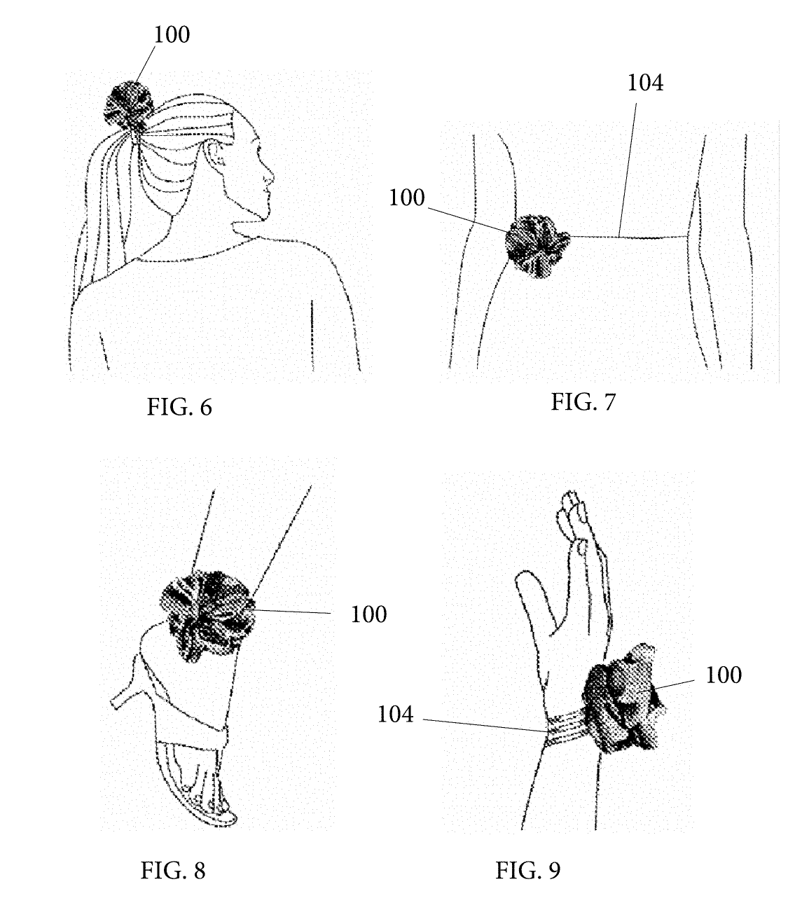

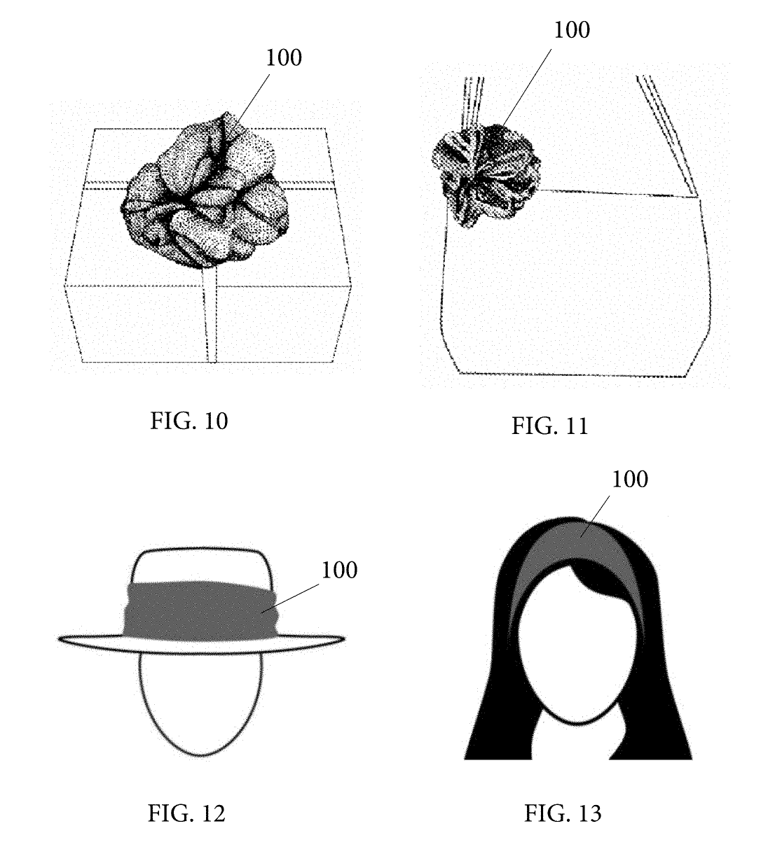

FIG. 4 is an environmental view of one embodiment of the multi-function band pulled and worn on a hat. FIG. 5 is an environmental view of one embodiment of the multi-function band pulled and worn as a hair band. FIG. 6 is an environmental view of one embodiment of the multi-function band pulled and worn as a hair band. FIG. 7 is an environmental view of one embodiment of the multi-function band pulled and worn as a waist band. FIG. 8 is an environmental view of one embodiment of the multi-function band pulled and worn as an ankle accessory. FIG. 9 is an environmental view of one embodiment of the multi-function band pulled and worn as a wrist accessory. FIG. 10 is an environmental view of one embodiment of the multi-function band pulled and used as a gift box accessory. FIG. 11 is an environmental view of one embodiment of the multi-function band pulled and used as a handbag accessory.

FIG. 12 is an environmental view of one embodiment of the multi-function band not pulled and used as a hat accessory. FIG. 13 is an environmental view of one embodiment of the multi-function band with the adjuster 104 not pulled and used as a head band. When the material of the multi-function band 100 is completely taught around the adjuster 104 when it is not pulled, then the multi-function band 100 resembles a headband. When the multi-function band 100 resembles a headband, it may be worn as a headband or it may be applied to an object as an accessory, such as a hat, as shown in FIG. 12.

It will also be appreciated that there are a plurality of ways or means for securing the adjuster 104 of the multi-function band 100 when partially or maximally operated or withdrawn. For example, multi-function band 100 may be equipped with one or more adjuster securing devices (not shown), such as hooks or clips disposed in proximity to the adjuster openings 103, and into which the withdrawn adjuster 104 may be inserted to secure the adjuster 104 at the desired point of operation or withdrawal. Alternatively, the withdrawn adjuster 104 may be secured by other means such as twisting or with one or more loops around the object or body part where the band 100 will be used.

In a preferred embodiment, for aesthetic purposes, the joint of the joined ends of the adjuster 104 is left within the cavity 102 to hide it from view.

In use, in one embodiment, a user may use the multi-function band 100 as a headband by pulling on the material of the multi-function band 100 in opposing directions so that the material of the multi-function band 100 substantially engulfs and covers the adjuster 104, wherein the material is taut and not gathered (see FIG. 13).

From this configuration, the user may also apply the headband to a hat or other object as an accessory (see FIG. 12).

In use, in another embodiment, a user may transform the multi-function band 100 into a hair tie, wherein the material of the multi-function band 100 is partially gathered or completely gathered, by grasping the adjuster 104 and pulling on the adjuster 104 to a desired length (see FIGS. 2 and 3). When the material of the multi-function band 100 is gathered, a resulting loop will appear that is formed from the adjuster 104. The resulting loop of the adjuster 104 allows the multi-function band 100 to be used as an aesthetically pleasing accessory, including, but not limited to, a headband (see FIG. 5), a hat accessory (see FIG. 4), a ponytail hair tie (see FIG. 6), a waist accessory or belt (see FIG. 7), an ankle accessory (see FIG. 8), a wrist accessory (see FIG. 9), a gift box accessory (see FIG. 10), or a handbag accessory (see FIG. 11). The Figures and description only depict some of the applications of the multi-function band 100 and is not intended to limit the potential applications for the multi-function band.

In an alternative embodiment, the multi-function band 100 may features a cord lock toggle that can be employed on the adjuster 104 when the adjuster is pulled so that the multi-function band 100 stays in a gathered formation. That is, the cord lock toggle may slide along the adjuster 104 until it is in contact with the material of the multi-function band 100 and then cord lock toggle may be locked in place and pressed against the adjuster 104, so that the material of the multi-function band 100 and the adjuster 104 do not move.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A wearable apparatus comprising:
a wearable cloth band;
said band having a string means therein, wherein pulling on said string means causes said band to gather into a different form, whereby the band has multiple wearable uses.

2. The apparatus of claim 1, wherein the string is elastic.

3. The apparatus of claim 1, wherein the band features at least two openings, whereby the openings are designed to allow a string to pass through.

4. The apparatus of claim 1, wherein a portion of the string is exposed outside of the band between the at least two openings.

5. The apparatus of claim 1, wherein the cloth band is further defined by polyester.

6. The apparatus of claim 1, wherein the cloth band is further defined by nylon.

7. The apparatus of claim 3, wherein the openings are reinforced with grommets.

8. The apparatus of claim 1, wherein the apparatus is further defined by a cord lock toggle disposed along the string.

9. A wearable apparatus comprising:
a cloth band, wherein the band features a hollow cavity within the band;
at least two openings in the band positioned in line with each other; and
an adjuster, wherein the adjuster is a closed loop that is threaded internally through the cavity and externally between the openings.

10. The wearable apparatus of claim 9, wherein the adjuster is an elastic string.

11. The wearable apparatus of claim 9, wherein the wearable apparatus is further defined by a cord lock toggle disposed along the adjuster.

12. The wearable apparatus of claim 9, wherein the openings are reinforced with grommets.

13. The apparatus of claim 9, wherein the cloth band is further defined by polyester.

14. The apparatus of claim 9, wherein the cloth band is further defined by nylon.

15. A method of converting a hairband comprising the steps of:
obtaining a multi-function band comprising a cloth band, wherein the band features a hollow cavity within the band, at least two openings in the band positioned in line with each other, and an adjuster, wherein the adjuster is a closed loop that is threaded internally through the cavity and externally between the openings, whereby the material of the band is taut and substantially covers the adjuster;
pulling on the exposed portion of the adjuster between the openings to a desired length, whereby the cloth band gathers and more of the adjuster is exposed to the external environment; and
applying the resulting loop from the adjuster to an object.

16. The method of claim 15 further defined by pulling on the gathered cloth band, whereby the cloth band slides along the adjuster until it substantially covers the adjuster, whereby the cloth band resembles a headband.
